(19) United States
(12) Patent Application Publication
(10) Pub. No.: US 2002/0057798 A1
(43) Pub. Date: May 16, 2002

(54) Method and apparatus employing one-way transforms

(76) Inventor: Jinglong F. Zhang, Fairfax, VA (US)

Correspondence Address: Jinglong Frank Zhang, 10909 Santa Clara Dr., Fairfax, VA, 22030, US

(21) Appl. No.: 09/939,810

(22) Filed: Aug. 28, 2001

Related U.S. Application Data
(60) Provisional application No. 60/231,526, filed on Sep. 11, 2000.

(51) Int. Cl. H04L 9/00

(52) U.S. Cl. 380/44

(57) ABSTRACT

This invention describes and specifies a cryptographic method/system employing one-way invertible transforms. In one embodiment, many different encryption keys can correspond to one single decryption key that decrypts different versions of ciphertext created by the many different encryption keys uniquely to the original plaintext; and in another embodiment one single encryption key can correspond to many different decryption keys that give different decrypted results. The encryption key is so constructed that it allows a high level of parallel computation.

### CROSS REFERENCE TO RELATED APPLICATION

This application is a continuation-in-part of my earlier U.S. provisional application Serial No. 60/231,526 filed on Sep. 11, 2000.

### BACKGROUND OF THE INVENTION

1. Field of the Invention

This invention relates to systems and devices that implement and make use of one-way transforms and to apparatuses and methods that realize the one-way property via processes and/or protocols.

2. Background Description

One-way transforms play an important role in forming the basis for data security. The idea of asymmetric invertible one-way transform was introduced in “New Directions in Cryptography” by W. Diffie and M. Hellman, IEEE Transactions on Information Theory, Vol. IT-22, 1976, pp. 644-654. Since then, many schemes and systems for the realization of asymmetric one-way functions came into being. The RSA cryptosystem is described in U.S. Pat. No. 4,405,829 to R. Rivest, A. Shamir and L. Adleman. The cryptosystem of T. ElGamal is depicted in “A Public Key Cryptosystem and a Signature Scheme based on Discrete Logarithms”, IEEE Transactions on Information Theory, Vol. 31, 1985, pp. 469-472. The more recently advanced cryptographic systems using elliptic curves started with V. Miller's paper “Use of Elliptic Curves in Cryptography”, Advances in Cryptology CRYPTO '85 Proceedings, Berlin: Springer-Verlag, 1985, pp. 417-426.

### OBJECTS AND SUMMARY OF THE INVENTION

It is an object of this invention to provide methods of invertible one-way transforms and to provide means of constructing devices that realize invertible one-way transforms. It is another object of this invention to improve on prior art and to provide better methods of realizing invertible one-way functions.

Encryption and decryption are respectively synonymous with the terms forward transform and backward transform used in the provisional application literature. Therefore, forward (backward) transform parameters are the parameters making up the encryption (decryption) key.

This invention facilitates unbalanced correspondence between encryption keys and decryption keys, where one correspondence defines the association of a single encryption key with many different decryption keys and another correspondence defines the association of a single decryption key with many different encryption keys. The cryptographic keys by this invention are complete where, once generated, no additional key parameters nor changes in either key parameters or key parameter values are required for performing encryption or decryption multiple times. Furthermore, the construction of the cryptographic keys of this invention has the potential for high parallelism to offer fast encryption.

### DETAILED DESCRIPTION OF PREFERRED EMBODIMENTS

Let the functions for generating the encryption and decryption keys be denoted by f( ) and b( ) respectively, and a cryptographic transform T using some parameters p by Tₚ( ). Then the following can hold for the transforms (i.e. encryption and decryption) of this invention:

for any determinant D and random input I and I′, I≠I′ if and

only if f(D, I)≠f(D, I′) and/or b(D, I)≠b(D, I′), and

for any x that is properly encoded, x=T_{b(D, I)}(T_{f(D, I)}(x))

where a determinant is a sequence of properly encoded symbols, the value of which determines, in conjunction with any applicable random input, both the actual cryptographic key parameters and the introduction of random noise.

In one embodiment of this invention, perfect revelation is realized through the use of a secrecy primitive, an entity associated with two parties who have different knowledge about said entity. In particular, some secret known to one party and securely conveyable to another party is contained in such an entity which itself is not required to be kept secret. By making use of this entity, the two parties can securely establish a second entity that is cryptographically symmetric, i.e. the two parties can share a secret.

In another embodiment, some encryption key parameters are converted to a different representation to facilitate other cryptographic techniques.

In still another embodiment, random noise independent of the value of any other cryptographic key parameter is incorporated.

In yet another embodiment, encryption key parameters are represented in self-contained (c.f. next paragraph for definition) components to facilitate independent calculation on these components.

An example is given here for illustration purposes. Let us assume X={x₁, x₂, . . . , xₙ} is a set of positive integers satisfying: xᵢ>(2^{h}−1)(x₁+x₂+ . . . +xᵢ₋₁) for 2≦i≦n, and is transformed to Y={y₁, y₂, . . . , yₙ} via one or more rounds of invertible strong modular multiplication (i.e. each modulus used is greater than the largest possible subset sum of the set that is being applied the strong modular multiplication). Suppose Z={z₁, z₂, . . . , zₙ} is the final transformed version with t−k≧0 noise components, where t is an arbitrary or random number and zᵢ for 1≦i≦n are vectors of t dimensions, denoted as zᵢ=(z_{i, 1}, z_{i, 2}, . . . , z_{i, t}). Let p₁, p₂, . . . , pₜ be t pairwise co-prime numbers and J={j₁, j₂, . . . , jₖ} be a set of randomly selected indices such that z_{ij=y}ᵢ% pⱼ if j∈J (where % denotes the modular function), and zᵢⱼ is a random number modulo pⱼ otherwise, and that the product of pⱼ for j∈J is greater than the largest possible subset sum of Y. In essence, Y is reduced to a residue system with arbitrary or random numbers inserted in arbitrarily or randomly picked dimensions in the vectors. This reduction by p₁, p₂, . . . , pₜ can also be multiplicative modular reduction. In such residue system representation, the zᵢⱼ's are self-contained, which means that, with regard to pertinent cryptographic operations, computation performed on yᵢ can be equivalently carried out with each individual of the zᵢⱼ independently. If we lay out Z, with each of its vector element as a row, we will have a matrix format:

z_{1, 1}, z_{1, 2}, . . . , z_{1, t}

z_{2, 1}, z_{2, 2}, . . . , z_{2, t}

. . .

z_{n, 1}, z_{n, 2}, . . . , z_{n, t}

and the random components are the columns of random numbers Zᵢⱼ for 1≦i≦n where j∉J. Z and pⱼ for 1≦j≦t are the encryption key, and are not required to be kept secret.

Let the data stream be assembled into nh-bit blocks with necessary padding of random bits, where each block is further divided into n sub-blocks d₁, d₂, . . . , dₙ of h bits each. A block is encrypted to c₁, c₂, . . . , cₜ in the following way:

cⱼ=(d₁z_{1, j}+d₂z_{2, j}+ . . . +dₙz_{n, j}) % pⱼ, for 1≦j≦t

The c_{j∉J}, for the mere purpose of recovering the original data, are simply discarded and ignored. Then the original data block is recovered via the recovery of the individual sub-blocks d₁, d₂, . . . , dₙ. One specific recovery processes is to convert the c_{j∈J} from the residue system by the pⱼ's using the Chinese Remainder Theorem to a subset sum of Y in the normal positional number system, and to then apply the round(s) of inverse strong modular multiplication. Finally, the normal decomposition of a superincreasing subset sum can be used to recover the sub-blocks d₁, d₂, . . . , dₙ.

Another type of one-way transform is carried out through the use of a secrecy primitive. In one embodiment, the method of elimination via a protocol can securely single out from the digitized secrecy primitive bits of interest as shared secret. However, in other embodiments, the shared secret can be established indirectly through the establishment of another shared secret. In the following example, one type of indirect establishment of a shared secret is manifested.

The general idea behind is that two parties, X and Y, will perform a protocol using a set of encryption keys as a secrecy primitive that may be known to observers. From the execution of the protocol, it is infeasible for an observer to deduce the secret established between X and Y, even though the observer learns everything of the actual transmissions between the two parties, besides having the knowledge of the encryption keys.

We assume that Y has m authentic encryption keys T₁, T₂, . . . , Tₘ for which X has the corresponding decryption keys and can learn about the values of certain bits encrypted. To be specific, we assume that X can learn the value of the tᵢ^{th} bit encrypted using Tⱼ. Y will encrypt random bits using the sets of encryption keys and send the encrypted version to X. X will instruct Y to perform certain actions, such as changing the logical index of the tᵢ^{th} bit as in the detailed demonstration that follows. By the end of the protocol, Y will be able to learn that X intended to convey the bit positions tᵢ. We assume the random data bit blocks used for T₁ are:

| | |
|---|---|
| 1^{st} data block: | 10111010001010110100111011010000 |
| 2^{nd} data block: | 11101010011110010101110111010100 |
| 3^{rd} data block: | 10001110101010100101110101010101 |
| 4^{th} data block: | 01001000111101100110101010011111 |
| 5^{th} data block: | 01110001011001000101110111011101 |
| 6^{th} data block: | 10100011011011001010100001110101 |

We also assume, without loss of generality, that tᵢ=11 and X intends to have Y logically change the indices tᵢ, for 1≦i≦m, to the target logical position 17, where the bit position is zero-oriented, counting from left. At the start, the physical positions and the logical positions are the same:

| | |
|---|---|
| PP | 0 1 2 3 4 5 6 7 8 9 10 11 12 13 14 15 16 17 18 19 20 21 22 23 24 25 26 27 28 29 30 31 |
| ILP | 0 1 2 3 4 5 6 7 8 9 10 11 12 13 14 15 16 17 18 19 20 21 22 23 24 25 26 27 28 29 30 31 |

Here PP stands for Physical Position, LP stands for Logical Position, ILP stands for Initial Logical Position, and FLP stands for Final Logical Position.

To logically move the bit from the 11^{th} position to the 17^{th} position we need to move right a total of 6 bits. We may randomly express 6 as the sum of k integers, i.e. we design it so that after k shifts, the 11^{th} bit is logically moved/changed to the 17^{th}. In our example, since we are using 6 data blocks, k will be 6, i.e. after 6 shifts we make sure the logical position of the 11^{th} bit is the 17^{th}. We assume that we have 6=2+(−8)+13+φ+0+(−1), where φ is a non-zero integer, functionally non-contributing to the sum (6). It indicates a shift that is not effective with regard to the bit of interest, i.e. the logical shift is done only to bits with value opposite to that of the bit of interest. The following is an example execution of the protocol.

Y encrypts the first data block and sends the encrypted version to X.

After decryption, X obtains the value of the 11^{th} bit in the data block to be 0. He instructs Y to logically right shift 2 positions (i.e. equivalently adding 2 to the logical position) all bits corresponding to the bits in the data block having value zero

Recall, the first number in the breakdown of 6 (into 2+(−8)+13+φ+0+(−1)) is 2 and that is how the right shift of 2 comes about. The physical positions (zero oriented) of the bits in the first data block having value zero are: 1, 5, 7, 8, 9, 11, 13, 16, 18, 19, 23, 26, 28, 29, 30, 31. The logical positions corresponding to those physical positions are incremented by 2 and the resulting logical positions will become:

| | |
|---|---|
| PP | 0 1 2 3 4 5 6 7 8 9 10 11 12 13 14 15 16 17 18 19 20 21 22 23 24 25 26 27 28 29 30 31 |
| LP | 0 3 2 3 4 7 6 9 10 11 10 13 12 15 14 15 18 17 20 21 20 21 22 25 24 25 28 27 30 31 0 1 |

Notice that the increment is addition modulo 32, i.e. with the block size as the modulus. In other words, the shift is cyclic in essence. Therefore, the logical positions 30 and 31 become 0 and 1 respectively after the increment.

The physical 11^{th} bit of the second data block (that is encrypted by Y) is 1, X instructs logical shifting of all one-bits−8 positions (or shifting left 8 positions). The one-bits in the second data block are in physical positions 0, 1, 2, 4, 6, 9, 10, 11, 12, 15, 17, 19, 20, 21, 23, 24, 25, 27 and 29. After logical shifting, the results are:

| | |
|---|---|
| PP | 0 1 2 3 4 5 6 7 8 9 10 11 12 13 14 15 16 17 18 19 20 21 22 23 24 25 26 27 28 29 30 31 |
| LP | 24 28 26 3 28 7 30 9 10 3 2 5 4 15 14 7 18 9 20 13 12 13 22 17 16 17 28 19 30 23 0 1 |

Similarly, the results from the third data block are:

| | |
|---|---|
| PP | 0 1 2 3 4 5 6 7 8 9 10 11 12 13 14 15 16 17 18 19 20 21 22 23 24 25 26 27 28 29 30 31 |
| LB | 24 9 7 16 28 7 30 22 10 16 2 18 4 28 14 20 31 9 31 13 12 13 3 17 7 17 9 19 11 23 13 1 |

In the fourth round, X is to instruct a fake shift (φ-shift), one that does not affect the logical index of the bit corresponding to the 11^{th} physical bit. Such an instruction is indicated by φ. After the fourth data block, for which we assume a right shift of 4 (i.e. φ=4) for the zero-bits because the 11^{th} bit has value 1, the logical positions become:

| | |
|---|---|
| PP | 0 1 2 3 4 5 6 7 8 9 10 11 12 13 14 15 16 17 18 19 20 21 22 23 24 25 26 27 28 29 30 31 |
| LP | 28 9 11 20 28 11 2 26 10 16 2 18 8 28 14 24 3 9 31 17 12 17 3 21 7 21 13 19 11 23 13 1 |

After the fifth data block, none of the logical positions changes as we instructed a zero shift. This is of course an actual no-operation, a waste that can be eliminated in actual practice. It is here, however, to illustrate the functional difference between an actual no-operation and a functional no-operation. Both contributes nothing to (6) the actual positions shifted for the bit of interest (11^{th}), but the φ-shift does change some logical indices.

After the last (sixth) data block, the logical positions finally become:

| | |
|---|---|
| PP | 0 1 2 3 4 5 6 7 8 9 10 11 12 13 14 15 16 17 18 19 20 21 22 23 24 25 26 27 28 29 30 31 |
| FLP | 28 8 11 19 27 10 2 26 9 16 2 17 8 28 13 23 3 8 31 16 12 16 2 20 6 21 13 19 10 23 12 1 |

The logical index value corresponding to the 11^{th} physical position is 17, functionally signifies that the 11^{th} physical position has now ‘logically’ become the 17^{th} as desired.

The same can be done with the other m−1 encryption keys, to move the tᵢ^{th} bit logically to the target logical position 17. This can be done either sequentially, one bit block after another, or better still in parallel. When the protocol completes, the logical index 17 must appear in each and every of the FLP rows. The identification process for tᵢ is as follows.

For any FLP row, if a certain logical index is missing, that logical index in all other (m−1) FLP rows is eliminated. For example in the above example, index 4 is not in the FLP row, then index 4 is eliminated from all other FLP rows. If after this elimination process, there are still more than one distinct logical index not eliminated, which will be very rare if k and m are chosen appropriately, the protocol can be re-executed or extended with more rounds. In other words, k can be increased with the application of more random bit blocks for each encryption key. When only one distinct logical index is left, the physical index corresponding to the logical index is the one X intends to communicate to Y. If Y again encrypts m random bit blocks β₁, β₂, . . . , βₘ using T₁, T₂, . . . , Tₘ respectively, X and Y would be able to share the knowledge of the value of the tᵢ^{th} bit in βᵢ. However, the remaining index in a FLP row could have multiple appearances. For instance, logical index 28 appears in both the 0^{th} and the 13^{th} entries in the FLP in the above example. Should X have chosen 28 as the target logical position to shift to, Y would still not be able to know if physical index 0 or 13 X intended. But this can be easily overcome with other means. Assuming, for example, that the i^{th} FLP row has more than one physical index corresponding to a logical index, bits of βᵢ in all those physical bit positions can be set to the same value so that the two parties can always have the same value for the tᵢ^{th} bit of βᵢ.

The above example of one-way transform realized via a protocol gets the one-way property from utilizing a set of encryption keys. Such encryption keys can have more than one distinct decryption keys that decrypt a same ciphertext to different results. One should notice that any entity possessing the authentic encryption keys will be able to execute the protocol with X, and an attacker can also compromise the contents of the communication between X and Y. Therefore, the legitimate communicating parties have to properly identify each other to guarantee that the encryption keys are authentic at party Y. Furthermore, they must make sure that their communication is not compromised, by applying data integrity techniques which abound in prior art.

It should be obvious and clear to one skilled in the art that the examples are for illustration purposes only. Parameters and assumptions used in the examples are for the convenience of explanation of this invention. In practice and actual implementation of this invention, proper parameters and parameter values should be chosen to meet the requirements of the applications.

I claim:

1. A cryptographic method, where a non-empty set F of encryption keys F₁, F₂, F₃, . . . are associated with one single decryption key B satisfying b(f(m))=m for any input m and for b being a decryption function employing B and for f being an encryption function employing any Fᵢ∈F, comprising:
obtaining arbitrary and/or random input from which cryptographic keys are generated;
generating a decryption key;
generating one of a plurality of corresponding encryption keys;
supplying an encryptor with said encryption key;
accepting a message m;
encrypting m by said encryptor to ciphertext c using said encryption key;
supplying a decryptor with said decryption key; and
decrypting c by said decryptor to recover m using said decryption key.

2. A cryptographic method for establishing a secret between two parties comprising:
generating a secrecy primitive; and
establishing said secret between said two parties using said secrecy primitive.

3. A cryptographic method as in claim 1 comprising:
obtaining arbitrary and/or random input from which cryptographic keys are generated;
generating a decryption key;
generating a corresponding encryption key through a series of transforms where at least one of said transforms facilitates the introduction of arbitrary or random noise of any desired sufficient amount;
supplying an encryptor with said encryption key;
accepting a message m;
encrypting m by said encryptor to ciphertext c using said encryption key;
supplying a decryptor with said decryption key; and
decrypting c by said decryptor to recover m using said decryption key.

4. A cryptographic method as in claim 1 comprising:
obtaining arbitrary and/or random input from which cryptographic keys are generated;
generating a decryption key including a set of parameters p in normal positional number representation;
generating a corresponding encryption key comprising:
converting p to self-contained components;
constructing encryption key parameters from said self-contained components by inserting zero or more arbitrary/random components in arbitrarily or randomly chosen component positions; and
generating all other encryption key parameters;
supplying an encryptor with said encryption key;
accepting a message m;
encrypting m by said encryptor to ciphertext C using said encryption key;
supplying a decryptor with said decryption key; and
decrypting c by said decryptor to recover m using said decryption key.

5. A cryptographic method, as in claim 1, adopting n integer functions f₁, f₂, . . . , fₙ mapping from [0, 2^{h}) to [0, 2^{h}+δ), where h>1 and 2^{h}+δ>1, comprising:
obtaining arbitrary and/or random input from which cryptographic keys are generated;
generating a decryption key, including the generation of a first set of positive integers X={x₁, x₂, . . . , xₙ} and a second set of positive integers W={w₁, w₂, . . . , wₙ} satisfying xᵢ>β₁x₁+β₂x₂+ . . . +βᵢ₋₁xᵢ₋₁+γ₁w₁+γ₂w₂+ . . . +γᵢwᵢ where, for 1≦i≦n, γᵢ=fᵢ(βᵢ) and βᵢ∈[0, 2^{h});
transforming X to Y={y₁, y₂, . . . , yₙ} and W to U={u₁, u₂, . . . , uₙ}, including an optional permutation and one or more rounds of invertible strong modular multiplication; and
further transforming Y to Z={z₁, z₂, . . . , zₙ} and U to V={v₁, v₂, . . . , vₙ} satisfying the following:
a. p₀, p₁, . . . , pₜ₋₁ are pairwise co-prime
b. zᵢ=(z_{i, 0}, z_{i, 1}, . . . , z_{i, qt-1}) for 1≦i≦n and q≧1
c. J={j₀, j₁, . . . , jₖ₋₁} is a set of arbitrary or random indices where 0≦j₀, j₂, . . . , jₖ₋₁<t
d. S={s₀, s₁, . . . , sₖ₋₁} is an arbitrary or random set satisfying:
0≦s₀, s₁, . . . , sₖ₋₁<qt, and S % t={s₀%t, s₁%t, . . . , sₖ₋₁%t}=J
e. Πp_{j∈J}>β₁y₁+β₂y₂+ . . . +βₙyₙ+γ₁u₁+γ₂u₂+ . . . +γₙuₙ
f. z_{i, s∈S}=yᵢ% p_{s%t}
g. z_{i, s∈S∉S} are arbitrary or random numbers modulo p_{s%t} for 0≦s<qt
h. vᵢ=(v_{i, 0}, v_{i, 1}, . . . , v_{i, qt-1}) for 1≦i≦n
i. v_{i, s∈S}=wᵢ % p_{s%t}
j. v_{i, s∉S} are arbitrary or random numbers modulo p_{s%t} for 0≦s<qt.

6. A cryptographic method as in claim 5 further comprising:
supplying an encryptor with said encryption key;
encrypting by said encryptor one or more nh-bit data blocks which are divided into h-bit sub-blocks d₁, d₂, . . . , where each block is encrypted to c=(c₀, c₁, . . . , c_{qt-1}) with cₛ=(d₁z_{1, s}+d₂z_{2, s}+ . . . +dₙz_{n, x}+f₁(d₁)v_{1, s}+f₂(d₂)v_{2, s}+ . . . +fₙ(dₙ)v_{n, s}) % p_{s%t for} 0≦s<qt;
supplying a decryptor with said decryption key; and
decrypting by said decryptor each of said encrypted blocks C to recover said data blocks, by extracting C={cₛ|s∈S} from c and by repeating, for each dᵢ for 1≦i≦n, the following:
a. converting C to a form where dᵢ can be determined
b. obtaining dᵢ from said converted C
c. removing from said converted C the quantity that dᵢ introduced.

7. A cryptographic method as in claim 6, where said encryption is carried out, in lieu, independently on self-contained components, comprising:
calculating c by carrying out two or more of said additions (+) and/or by computing two or more of said terms dᵢzᵢⱼ and fᵢ(dᵢ)v_{i, j} in parallel.

8. A cryptographic method, as in claim 1, for communicating a message securely from a first party E to a second party D comprising:
obtaining at party D arbitrary and/or random input from which cryptographic keys are generated;
generating at party D a decryption key to be kept secret;
generating at party D one of a plurality of corresponding encryption keys;
distributing said encryption key from party D to party E;
accepting a message m at party E;
encrypting m to ciphertext at party E, employing said encryption key;
transmitting said ciphertext from party E to party D;
receiving said ciphertext at party D; and
decrypting said ciphertext at party D to recover m, employing said decryption key.

9. A cryptographic method as in claim 8 further comprising:
applying chaining in the encryption of m to c with zero or more blocks of arbitrary or random bits pre-pended to m.

10. A cryptographic method, as in claim 5, using dynamic mapping for communicating a message securely from a first party E to a second party D which generates said encryption key to be kept secret and said decryption key to be sent to party E, further comprising:
agreeing upon a set of mapping functions f₁, f₂, . . . , fₙ for said current communication by said two parties, where said set of mapping functions only observe their domain and range restrictions and are independent of and unrelated to any other encryption or decryption parameters;
distributing said encryption key from party D to party E;
accepting a message m at party E;
encrypting m to ciphertext at party E, employing said encryption key and f₁, f₂, . . . , fₙ;
transmitting said ciphertext from party E to party D over a communication channel;
receiving said ciphertext at party D; and
decrypting said ciphertext at party D to recover m, employing said decryption key and f₁, f₂, . . . , fₙ.

11. A cryptographic method, as in claim 2, where one encryption key Fₓ is associated with a non-empty set Bₓ of decryption keys B_{x, 1}, B_{x, 2}, . . . , B_{x, n} satisfying bᵢ(f(m))≠bⱼ(f(m)) for one or more input m if i≠j, with bᵢ and bⱼ being decryption functions employing B_{x, i} and B_{x, j} respectively and f being an encryption function employing Fₓ, comprising:
obtaining at a first party D arbitrary and/or random input from which cryptographic keys are generated;
generating at party D secret decryption keys B¹, B², . . . , B^{k} where B^{x}∈Bₓ for 1≦y≦k;
generating at party D encryption keys F₁, F₂, . . . , Fₖ as said secrecy primitive, where Fₓ corresponds to Bₓ for 1≦x≦k;
distributing said encryption keys from party D to a second party E; and
establishing said secret between said two parties by making use of said encryption keys and decryption keys.

12. A cryptographic method, as in claim 11, for establishing said secret comprising:
generating at party D said encryption keys and decryption keys;
distributing said encryption keys from party D to party E;
receiving said encryption keys at party E;
encrypting arbitrary or random data blocks at party E employing said encryption keys;
transmitting said encrypted data blocks from party E to party D over a communication channel;
receiving at party D said encrypted data blocks from party E;
decrypting said encrypted data blocks employing said decryption keys at party D to obtain information/characteristics about said data blocks; and
communicating to party E by party D, based on said information/characteristics gained about said data blocks, instructions to transform a special entity to a form from which party E learns said secret party D intends to convey and establish.

13. A cryptographic method as in claim 12 further comprising:
using said established secret for further secure communications and cryptographic applications between said two parties.

14. A cryptographic method as in claim 1 for the zero-knowledge authentication/identification of a party possessing said secret decryption key comprising:
proving said authenticity/identity by said party through the exhibition of the ability to decrypt any valid encrypted messages using said decryption key.

15. A cryptographic system, where a non-empty set F of complete encryption keys F₁, F₂, F₃, . . . are associated with one single decryption key B satisfying b(f(m))=m for any input m and for b being a decryption mechanism employing B and for f being an encryption mechanism employing any Fᵢ∈F, comprising:
means for obtaining arbitrary and/or random input from which cryptographic keys are generated;
means for generating a decryption key;
means for generating one of a plurality of corresponding encryption keys;
means for supplying an encryptor with said encryption key;
means for accepting a message m;
means for encrypting m by said encryptor to ciphertext C using said encryption key;
means for supplying a decryptor with said decryption key; and
means for decrypting c by said decryptor to recover m using said decryption key.

16. A cryptographic system as in claim 15 comprising:
means for obtaining arbitrary and/or random input from which cryptographic keys are generated;
means for generating a decryption key including a set of parameters p in normal positional number representation;
means for generating a corresponding encryption key comprising:
means for converting p to self-contained components;
means for constructing encryption key parameters from said self-contained components by inserting zero or more arbitrary/random components in arbitrarily or randomly chosen component positions; and
means for generating all other encryption key parameters;
means for supplying an encryptor with said encryption key;
means for accepting a message m;
means for encrypting m by said encryptor to ciphertext c using said encryption key;
means for supplying a decryptor with said decryption key; and
means for decrypting c by said decryptor to recover m using said decryption key.

17. A cryptographic system, as in claim 15, with means for implementing n integer functions f₁, f₂, . . . , fₙ mapping from [0, 2^{h}) to [0, 2^{h}+δ), where h>1 and 2^{h}+δ>1, comprising:
means for obtaining arbitrary and/or random input from which cryptographic keys are generated;
means for generating a decryption key, including the generation of a first set of positive integers X={x₁, x₂, . . . , xₙ} and a second set of positive integers W={w₁, w₂, . . . , wₙ} satisfying xᵢ>β₁x₁+β₂x₂+ . . . +βᵢ₋₁xᵢ₋₁+γ₁w₁+γ₂w₂+ . . . +γᵢwᵢ where, for 1≦i≦n, γᵢ=fᵢ(βᵢ) and βᵢ∈[0, 2^{h});
means for transforming X to Y={y₁, y₂, . . . , yₙ} and W to U={u₁, u₂, . . . , uₙ}, including an optional permutation and one or more rounds of invertible strong modular multiplication;
means for further transforming Y to Z={z₁, z₂, . . . , zₙ} and U to V={v₁, v₂, . . . , vₙ} satisfying the following:
a. p₀, p₁, . . . , pₜ₋₁ are pairwise co-prime
b. zᵢ=(z_{i, 0}, z_{i, 1}, . . . , z_{i, qt-1}) for 1≦i≦n and q≧1
c. J={j₀, j₁, . . . , jₖ₋₁} is a set of arbitrary or random indices where 0≦j₀, j₂, . . . , jₖ₋₁<t
d. S={s₀, s₁, . . . , sₖ₋₁} is an arbitrary or random set satisfying:
0≦s₀, s₁, . . . , sₖ₋₁<qt, and S % t={s₀%t, s₁%t, . . . , sₖ₋₁%t}=J
e. Πp_{j∈J}>β₁y₁+β₂y₂+ . . . +βₙyₙ+γ₁u₁+γ₂u₂+ . . . +γₙuₙ
f. z_{i, s∈S}=yᵢ % p_{s%t}
g. z_{i, s∉S} are arbitrary or random numbers modulo p_{s%t} for 0≦s<qt
h. vᵢ=(v_{i, 0}, v_{i, 1}, . . . , v_{i, qt-1}) for 1≦i≦n
i. v_{i, s∈S}=wᵢ % p_{s%t}
j. v_{i, s∉S} are arbitrary or random numbers modulo p_{s%t} for 0≦s<qt.

18. A cryptographic system as in claim 17 further comprising:
means for supplying an encryptor with said encryption key;
means for encrypting by said encryptor one or more nh-bit data blocks which are divided into h-bit sub-blocks d₁, d₂, . . . , dₙ, where each block is encrypted to c=(c₀, c₁, . . . , c_{qt-1}) with cₛ=(d₁z_{1, s}+d₂z_{2, s}+ . . . +dₙz_{n, s}+f₁(d₁)v_{1, s}+f₂(d₂)v_{2, s}+ . . . +fₙ(dₙ)v_{n, s}) % p_{s%t} for 0≦s<qt;
means for supplying a decryptor with said decryption key; and
means for decrypting by said decryptor each of said encrypted blocks c to recover said data blocks, by extracting C={cₛ|s∈S} from c and by repeating, for each dᵢ for 1≦i≦n, the following:
a. converting C to a form where dᵢ can be determined
b. obtaining dᵢ from said converted C
c. removing from said converted C the quantity that dᵢ introduced.

19. A cryptographic system as in claim 18, where said encryption is carried out, in lieu, independently on self-contained components, comprising:
means for calculating c by carrying out two or more of said additions (+) and/or by computing two or more of said terms dᵢzᵢⱼ and fᵢ(dᵢ)vᵢⱼ in parallel.

20. A cryptographic system, as in claim 15, for communicating a message securely from a first party E to a second party D comprising:
means for obtaining at party D arbitrary and/or random input from which cryptographic keys are generated;
means for generating at party D a decryption key to be kept secret;
means for generating at party D one of a plurality of corresponding encryption keys;
means for distributing said encryption key from party D to party E;
means for accepting a message m at party E;
means for encrypting m to ciphertext at party E, employing encryption key;
means for transmitting said ciphertext from party E to party D;
means for receiving said ciphertext at party D; and
means for decrypting said ciphertext at party D to recover m, employing said decryption key.
